(19) United States
(12) Patent Application Publication
(10) Pub. No.: US 2025/0362481 A1
(43) Pub. Date: Nov. 27, 2025

(54) WIDE-ANGLE LENS ASSEMBLY

(71) Applicant: Asia Optical Co., Inc., Taichung (TW)

(72) Inventor: Li-Kai Wang, Taichung (TW)

(21) Appl. No.: 18/985,309

(22) Filed: Dec. 18, 2024

(30) Foreign Application Priority Data
May 24, 2024 (CN) 202410657040.7

(51) Int. Cl. G02B 13/00; G02B 9/62; G02B 13/06

(52) U.S. Cl. CPC G02B 13/0045; G02B 9/62; G02B 13/06

(57) ABSTRACT

A wide-angle lens assembly includes a first lens, a second lens, a third lens, a fourth lens, a fifth lens, and a sixth lens. The first lens is with refractive power. The second lens is with refractive power and includes a convex surface facing an object side. The third lens is with positive refractive power. The fourth lens is with refractive power and includes a convex surface facing the object side. The fifth lens is with positive refractive power and includes a convex surface facing the object side. The sixth lens is with refractive power and includes a concave surface facing an image side. The first lens, the second lens, the third lens, the fourth lens, the fifth lens, and the sixth lens are arranged in order from the object side to the image side along an optical axis.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is developed to have miniaturization and high resolution in accordance with different application requirements. However, the known wide-angle lens assembly can't satisfy such requirements. Therefore, the wide-angle lens assembly needs a new structure in order to meet the requirements of large field of view, miniaturization, and high resolution at the same time.

### BRIEF SUMMARY OF THE INVENTION

The invention provides a wide-angle lens assembly to solve the above problems. The wide-angle lens assembly of the invention is provided with characteristics of an increased field of view, a decreased total lens length, an increased resolution, and still has a good optical performance.

The wide-angle lens assembly in accordance with an exemplary embodiment of the invention includes a first lens, a second lens, a third lens, a fourth lens, a fifth lens, and a sixth lens. The first lens is with refractive power. The second lens is with refractive power and includes a convex surface facing an object side. The third lens is with positive refractive power. The fourth lens is with refractive power and includes a convex surface facing the object side. The fifth lens is with positive refractive power and includes a convex surface facing the object side. The sixth lens is with refractive power and includes a concave surface facing an image side. The first lens, the second lens, the third lens, the fourth lens, the fifth lens, and the sixth lens are arranged in order from the object side to the image side along an optical axis. A wide-angle lens assembly of the present invention can achieve basic operation when the wide-angle lens assembly satisfies the above features and does not need other additional features or conditions.

In another exemplary embodiment, the wide-angle lens assembly satisfies at least one of the following conditions: 24 mm²≤(R41−R51)×T3≤42 mm^{2;} 0.1≤(f1+f5)/d34≤10.7; 5.01 mm≤(f1−f6)×Vd4≤20.31 mm; 10 mm≤(R22)²/f3≤33 mm; 3.9 mm²≤(T1+T4+T5)×f3≤11.5 mm²; 9 mm≤(f6)²/(R11+R22)≤19 mm; 9.5 mm⁻¹≤R52/R61/d34≤27.2 mm⁻¹; 9≤(R61)/((f6/f4)+R52)≤12.2; 20 mm⁻²≤Nd3/(R31×d34)≤55 mm⁻²; 152 mm≤(T1+T2+T3+T4+T5+T6)²/(R32+R42)≤274 mm; wherein f1 is an effective focal length of the first lens, f3 is an effective focal length of the third lens, f4 is an effective focal length of the fourth lens, f5 is an effective focal length of the fifth lens, f6 is an effective focal length of the sixth lens, T1 is an interval from an object side surface of the first lens to an image side surface of the first lens along the optical axis, T2 is an interval from an object side surface of the second lens to an image side surface of the second lens along the optical axis, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, R42 is a radius of curvature of the image side surface of the fourth lens, R51 is a radius of curvature of the object side surface of the fifth lens, R52 is a radius of curvature of the image side surface of the fifth lens, R61 is a radius of curvature of the object side surface of the sixth lens, 34 is an air interval from the image side surface of the third lens to the object side surface of the fourth lens along the optical axis, Vd4 is an Abbe number of the fourth lens, and Nd3 is a refractive index of the third lens.

In yet another exemplary embodiment, the first lens is with negative refractive power; the fourth lens is with negative refractive power; and the sixth lens is with negative refractive power.

In another exemplary embodiment, the first lens is a meniscus lens and includes a convex surface facing the object side and a concave surface facing the image side; the third lens is a biconvex lens and includes a convex surface facing the object side and another convex surface facing the image side; the fourth lens is a meniscus lens and further includes a concave surface facing the image side; the fifth lens is a biconvex lens and further includes another convex surface facing the image side; and the sixth lens is a biconcave lens and further includes another concave surface facing the object side.

In yet another exemplary embodiment, the wide-angle lens assembly further includes a stop disposed between the second lens and the third lens.

In another exemplary embodiment, the second lens is a biconvex lens with positive refractive power and further includes another convex surface facing the image side.

The wide-angle lens assembly in accordance with another exemplary embodiment of the invention includes a first lens, a second lens, a third lens, a fourth lens, a fifth lens, and a sixth lens. The first lens is with refractive power. The second lens is a biconvex lens with positive refractive power and includes a convex surface facing an object side and another convex surface facing the image side. The third lens is with positive refractive power. The fourth lens is with refractive power and includes a convex surface facing the object side. The fifth lens is with refractive power. The sixth lens is with refractive power and includes a concave surface facing the image side. The first lens, the second lens, the third lens, the fourth lens, the fifth lens, and the sixth lens are arranged in order from the object side to the image side along an optical axis.

In another exemplary embodiment, the wide-angle lens assembly satisfies at least one of the following conditions: 24 mm²≤(R41−R51)×T3≤42 mm²; 0.1≤(f1+f5)/d34≤10.7; 5.01 mm≤(f1−f6)×Vd4≤20.31 mm; 10 mm≤(R22)²/f3≤33 mm; 3.9 mm²≤(T1+T4+T5)×f3≤11.5 mm²; 9 mm≤(f6)²/(R11+R22)≤19 mm; 9.5 mm⁻¹<R52/R61/d34≤27.2 mm⁻¹; 9≤(R61)/((f6/f4)+R52)≤12.2; 20 mm⁻²≤Nd3/(R31×d34)≤55 mm⁻²; 152 mm≤(T1+T2+T3+T4+T5+T6)²/(R32+R42)≤274 mm; wherein f1 is an effective focal length of the first lens, f3 is an effective focal length of the third lens, f4 is an effective focal length of the fourth lens, f5 is an effective focal length of the fifth lens, f6 is an effective focal length of the sixth lens, T1 is an interval from an object side surface of the first lens to an image side surface of the first lens along the optical axis, T2 is an interval from an object side surface of the second lens to an image side surface of the second lens along the optical axis, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, R42 is a radius of curvature of the image side surface of the fourth lens, R51 is a radius of curvature of the object side surface of the fifth lens, R52 is a radius of curvature of the image side surface of the fifth lens, R61 is a radius of curvature of the object side surface of the sixth lens, 34 is an air interval from the image side surface of the third lens to the object side surface of the fourth lens along the optical axis, Vd4 is an Abbe number of the fourth lens, and Nd3 is a refractive index of the third lens.

In yet another exemplary embodiment, the first lens is with negative refractive power; the fourth lens is with negative refractive power; and the sixth lens is with negative refractive power.

In another exemplary embodiment, the first lens is a meniscus lens and includes a convex surface facing the object side and a concave surface facing the image side; the third lens is a biconvex lens and includes a convex surface facing the object side and another convex surface facing the image side; the fourth lens is a meniscus lens and further includes a concave surface facing the image side; the fifth lens is a biconvex lens and includes a convex surface facing the object side and another convex surface facing the image side; and the sixth lens is a biconcave lens and further includes another concave surface facing the object side.

In yet another exemplary embodiment, the wide-angle lens assembly further includes a stop disposed between the second lens and the third lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1, 6, 11 are lens layout diagrams of wide-angle lens assemblies in accordance with a first, second, and third embodiments of the invention, respectively;

FIGS. 2, 3, 4, 5 depict a longitudinal aberration diagram, a field curvature diagram, a distortion diagram, and a relative illumination diagram of the wide-angle lens assembly in accordance with the first embodiment of the invention, respectively;

FIGS. 7, 8, 9, 10 depict a longitudinal aberration diagram, a field curvature diagram, a distortion diagram, and a relative illumination diagram of the wide-angle lens assembly in accordance with the second embodiment of the invention, respectively; and

FIGS. 12, 13, 14, 15 depict a longitudinal aberration diagram, a field curvature diagram, a distortion diagram, and a relative illumination diagram of the wide-angle lens assembly in accordance with the third embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, and a sixth lens. The first lens is with refractive power. The second lens is with refractive power and includes a convex surface facing an object side. The third lens is with positive refractive power. The fourth lens is with refractive power and includes a convex surface facing the object side. The fifth lens is with positive refractive power and includes a convex surface facing the object side. The sixth lens is with refractive power and includes a concave surface facing an image side. The first lens, the second lens, the third lens, the fourth lens, the fifth lens, and the sixth lens are arranged in order from the object side to the image side along an optical axis. A wide-angle lens assembly of the present invention is a preferred embodiment of the present invention when the wide-angle lens assembly satisfies the above features.

The present invention provides another wide-angle lens assembly including a first lens, a second lens, a third lens, a fourth lens, a fifth lens, and a sixth lens. The first lens is with refractive power. The second lens is a biconvex lens with positive refractive power and includes a convex surface facing an object side and another convex surface facing an image side. The third lens is with positive refractive power. The fourth lens is with refractive power and includes a convex surface facing the object side. The fifth lens is with refractive power. The sixth lens is with refractive power and includes a concave surface facing the image side. The first lens, the second lens, the third lens, the fourth lens, the fifth lens, and the sixth lens are arranged in order from the object side to the image side along an optical axis. A wide-angle lens assembly of the present invention is a preferred embodiment of the present invention when the wide-angle lens assembly satisfies the above features.

Referring to Table 1, Table 2, Table 4, Table 5, Table 7, and Table 8, wherein Table 1, Table 4, and Table 7 show optical specification in accordance with a first, second, and third embodiments of the invention, respectively and Table 2, Table 5, and Table 8 show aspheric coefficients of each aspheric lens in Table 1, Table 4, and Table 7, respectively. The aspheric surface sag z of each aspheric lens in the following embodiments can be calculated by the following formula: z=ch²/{1+[1−(k+1)c²h²]^{1/2}}+Ah⁴+Bh⁶+Ch⁸+Dh¹⁰+Eh¹², where c is curvature, h is the vertical distance from the lens surface to the optical axis, k is conic constant, A, B, C, D, and E are aspheric coefficients, and the value of the aspheric coefficient A, B, C, D, and E are presented in scientific notation, such as 2E-03 for 2×10⁻³.

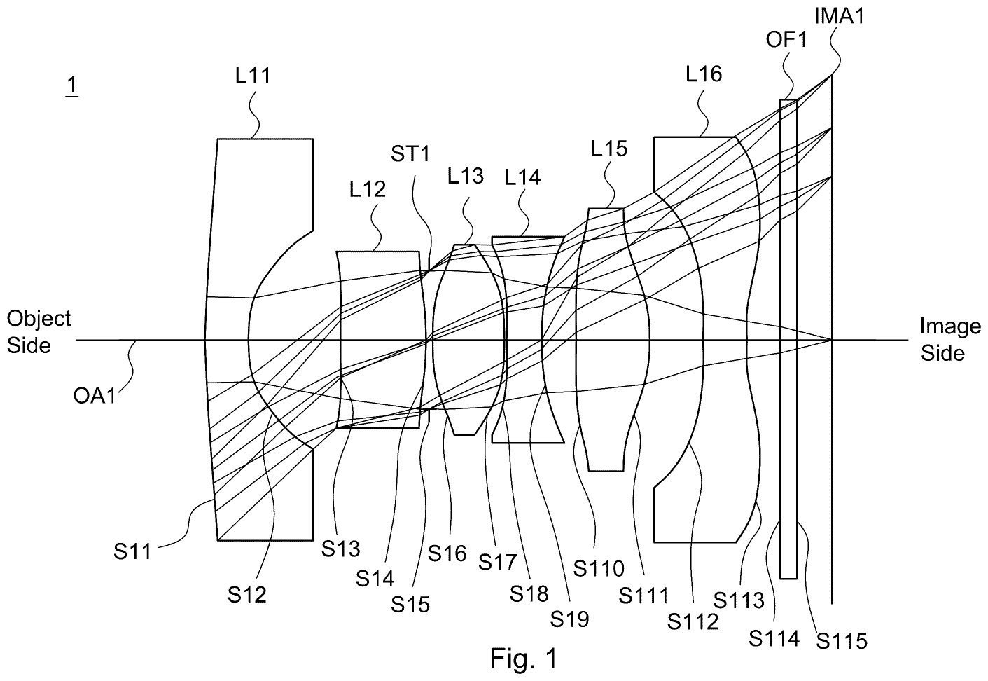

FIGS. 1, 6, 11 are lens layout diagrams of the lens assemblies in accordance with the first, second, and third embodiments of the invention, respectively.

The first lenses L11, L21, L31 are meniscus lenses with negative refractive power and made of plastic material, wherein the object side surfaces S11, S21, S31 are convex surfaces, the image side surfaces S12, S22, S32 are concave surfaces, and both of the object side surfaces S11, S21, S31 and image side surfaces S12, S22, S32 are aspheric surfaces.

The second lenses L12, L22, L32 are biconvex lenses with positive refractive power and made of plastic material, wherein the object side surfaces S13, S23, S33 are convex surfaces, the image side surfaces S14, S24, S34 are convex surfaces, and both of the object side surfaces S13, S23, S33 and image side surfaces S14, S24, S34 are aspheric surfaces.

The third lenses L13, L23, L33 are biconvex lenses with positive refractive power and made of plastic material, wherein the object side surfaces S16, S26, S36 are convex surfaces, the image side surfaces S17, S27, S37 are convex surfaces, and both of the object side surfaces S16, S26, S36 and image side surfaces S17, S27, S37 are aspheric surfaces.

The fourth lenses L14, L24, L34 are meniscus lenses with negative refractive power and made of plastic material, wherein the object side surfaces S18, S28, S38 are convex surfaces, the image side surfaces S19, S29, S39 are concave surfaces, and both of the object side surfaces S18, S28, S38 and image side surfaces S19, S29, S39 are aspheric surfaces.

The fifth lenses L15, L25, L35 are biconvex lenses with positive refractive power and made of plastic material, wherein the object side surfaces S110, S210, S310 are convex surfaces, the image side surfaces S111, S211, S311 are convex surfaces, and both of the object side surfaces S110, S210, S310 and image side surfaces S111, S211, S311 are aspheric surfaces.

The sixth lenses L16, L26, L36 are biconcave lenses with negative refractive power and made of plastic material, wherein the object side surfaces S112, S212, S312 are concave surfaces, the image side surfaces S113, S213, S313 are concave surfaces, and both of the object side surfaces S112, S212, S312 and image side surfaces S113, S213, S313 are aspheric surfaces.

In addition, the wide-angle lens assemblies 1, 2, and 3 satisfy at least one of the following conditions (1)-(10):

$$24 {mm}^{2} \leq ( R 41 - R 51 ) \times T 3 \leq 42 {mm}^{2} ; \qquad ( 1 )$$

$$0.1 \leq ( f 1 + f 5 ) / d 34 \leq 10.7 ; \qquad ( 2 )$$

$$5.01 mm \leq ( f 1 - f 6 ) \times Vd 4 \leq 20.31 mm ; \qquad ( 3 )$$

$$10 mm \leq {( R 22 )}^{2} / f 3 \leq 33 mm ; \qquad ( 4 )$$

$$3.9 {mm}^{2} \leq ( T 1 + T 4 + T 5 ) \times f 3 \leq 11.5 {mm}^{2} ; \qquad ( 5 )$$

$$9 mm \leq {( f 6 )}^{2} / ( R 11 + R 22 ) \leq 19 mm ; \qquad ( 6 )$$

$$9.5 {mm}^{- 1} \leq R 52 / R 61 / d 34 \leq 27.2 {mm}^{- 1} ; \qquad ( 7 )$$

$$9 \leq ( R 61 ) / ( ( f 6 / f 4 ) + R 52 ) \leq 12.2 ; \qquad ( 8 )$$

$$20 {mm}^{- 2} \leq Nd 3 / ( R 31 \times d 34 ) \leq 55 {mm}^{- 2} ; \qquad ( 9 )$$

$$152 mm \leq {( T 1 + T 2 + T 3 + T 4 + T 5 + T 6 )}^{2} / ( R 32 + R 42 ) \leq 274 mm ; \qquad ( 10 )$$

wherein the parameters in the first to third embodiments are defined as follows: f1 is an effective focal length of the first lenses L11, L21, L31; f3 is an effective focal length of the third lenses L13, L23, L33; f4 is an effective focal length of the fourth lenses L14, L24, L34; f5 is an effective focal length of the fifth lenses L15, L25, L35; f6 is an effective focal length of the sixth lenses L16, L26, L36; T1 is an interval from the object side surfaces S11, S21, S31 of the first lenses L11, L21, L31 to the image side surfaces S12, S22, S32 of the first lenses L11, L21, L31 along the optical axes OA1, OA2, OA3; T2 is an interval from the object side surfaces S13, S23, S33 of the second lenses L12, L22, L32 to the image side surfaces S14, S24, S34 of the second lenses L12, L22, L32 along the optical axes OA1, OA2, OA3; T3 is an interval from the object side surfaces S16, S26, S36 of the third lenses L13, L23, L33 to the image side surfaces S17, S27, S37 of the third lenses L13, L23, L33 along the optical axes OA1, OA2, OA3; T4 is an interval from the object side surfaces S18, 28, S38 of the fourth lenses L14, L24, L34 to the image side surfaces S19, S29, S39 of the fourth lenses L14, L24, L34 along the optical axes OA1, OA2, OA3; T5 is an interval from the object side surfaces S110, S210, S310 of the fifth lenses L15, L25, L35 to the image side surfaces S111, S211, S311 of the fifth lenses L15, L25, L35 along the optical axes OA1, OA2, OA3; T6 is an interval from the object side surfaces S112, S212, S312 of the sixth lenses L16, L26, L36 to the image side surfaces S113, S213, S313 of the sixth lenses L16, L26, L36 along the optical axes OA1, OA2, OA3; R11 is a radius of curvature of the object side surfaces S11, S21, S31 of the first lenses L11, L21, L31; R22 is a radius of curvature of the image side surfaces S14, S24, S34 of the second lenses L12, L22, L32; R31 is a radius of curvature of the object side surfaces S16, S26, S36 of the third lenses L13, L23, L33; R32 is a radius of curvature of the image side surfaces S17, S27, S37 of the third lenses L13, L23, L33; R41 is a radius of curvature of the object side surfaces S18, S28, S38 of the fourth lenses L14, L24, L34; R42 is a radius of curvature of the image side surfaces S19, S29, S39 of the fourth lenses L14, L24, L34; R51 is a radius of curvature of the object side surfaces S110, S210, S310 of the fifth lenses L15, L25, L35; R52 is a radius of curvature of the image side surfaces S111, S211, S311 of the fifth lenses L15, L25, L35; R61 is a radius of curvature of the object side surfaces S112, S212, S312 of the sixth lenses L16, L26, L36; d34 is an air interval from the image side surfaces S17, S27, S37 of the third lenses L13, L23, L33 to the object side surfaces S18, S28, S38 of the fourth lenses L14, L24, L34 along the optical axes OA1, OA2, OA3; Vd4 is an Abbe number of the fourth lenses L14, L24, L34; and Nd3 is a refractive index of the third lenses L13, L23, L33. Making the lens assemblies 1, 2, and 3 effectively increasing the field of view, effectively shortening the total lens length, effectively increasing the resolution, and effectively correct aberration.

When the condition (1): 24 mm²≤(R41−R51)×T3≤42 mm² is satisfied, the aberration can be effectively corrected and the resolution can be effectively increased. When the condition (2): 0.1≤(f1+f5)/d34≤10.7 is satisfied, the aberration can be effectively corrected and the resolution can be effectively increased. When the condition (3): 5.01 mm≤(f1−f6)×Vd4≤20.31 mm is satisfied, the aberration can be effectively corrected and the resolution can be effectively increased. When the condition (4): 10 mm≤(R22)²/f3≤33 mm is satisfied, the radius of curvature and air interval can be effectively controlled to correct aberration. When the condition (5): 3.9 mm²≤(T1+T4+T5)×f3≤11.5 mm² is satisfied, the thicknesses of the first, fourth, and the fifth lenses and the effective focal length of the third lens can be effectively controlled to correct off-axis aberration. When the condition (6): 9 mm≤(f6)²/(R11+R22)≤19 mm is satisfied, the thickness and effective focal length can be effectively controlled to correct off-axis aberration. When the condition (7): 9.5 mm⁻¹≤R52/R61/d34≤27.2 mm⁻¹ is satisfied, the thickness and effective focal length can be effectively controlled to correct off-axis aberration. When the condition (8): 9≤(R61)/((f6/f4)+R52)≤12.2 is satisfied, the chromatic aberration can be effectively corrected and the resolution can be effectively increased. When the condition (9): 20 mm⁻²≤Nd3/(R31×d34)≤55 mm⁻² is satisfied, the refractive power of the wide-angle lens assembly can be effectively increased to control field of view and help correcting aberration. When the condition (10): 152 mm≤(T1+T2+T3+T4+T5+T6)²/(R32+R42)≤274 mm is satisfied, the aberration can be effectively corrected and the resolution can be effectively increased.

A detailed description of a wide-angle lens assembly in accordance with a first embodiment of the invention is as follows. Referring to FIG. 1, the wide-angle lens assembly 1 includes a first lens L11, a second lens L12, a stop ST1, a third lens L13, a fourth lens L14, a fifth lens L15, a sixth lens L16, and an optical filter OF1, all of which are arranged in order from an object side to an image side along an optical axis OA1. In operation, the light from the object side is imaged on an image plane IMA1.

According to the foregoing, wherein: both of the object side surface S114 and image side surface S115 of the optical filter OF1 are plane surfaces; and with the above design of the lenses, stop ST1, and at least one of the conditions (1)-(10) satisfied, the wide-angle lens assembly 1 can have an effective increased field of view, an effective shortened total lens length, an effective increased resolution, and an effective corrected aberration. When the wide-angle lens assembly of the present invention only satisfies condition (1), condition (2), condition (3), condition (4), condition (5), condition (6), condition (7), condition (8), condition (9), or condition (10); the third and fifth lenses respectively have positive, positive refractive power; the object side surface of the second lens is a convex surface; the object side surface of the fourth lens is a convex surface; the object side surface of the fifth lens is a convex surface; and the image side surface of the sixth lens is a concave surface; the basic operation requirements can be met. When the wide-angle lens assembly of the present invention only satisfies condition (1), condition (2), condition (3), condition (4), condition (5), condition (6), condition (7), condition (8), condition (9), or condition (10); the second and third lenses respectively have positive, positive refractive power; the object side surface of the second lens is a convex surface and the image side surface of the second lens is a convex surface; the object side surface of the fourth lens is a convex surface; and the image side surface of the sixth lens is a concave surface; the basic operation requirements can be met.

Table 1 shows the optical specification of the wide-angle lens assembly 1 in FIG. 1.

TABLE 1
Effective Focal Length = 2.61 mm F-number = 2.20
Total Lens Length = 8.61 mm Field of View = 167.84 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S11 | 9.00 | 0.59 | 1.54 | 56.00 | −3.54 | L11 |
| S12 | 1.56 | 1.26 | | | | |
| S13 | 28.11 | 1.18 | 1.64 | 23.97 | 10.03 | L12 |
| S14 | −8.19 | 0.05 | | | | |
| S15 | ∞ | 0.03 | | | | ST1 |
| S16 | 2.58 | 1.03 | 1.54 | 56.00 | 2.04 | L13 |
| S17 | −1.69 | 0.01 | | | | |
| S18 | 46.82 | 0.47 | 1.66 | 20.38 | −2.89 | L14 |
| S19 | 1.85 | 0.46 | | | | |
| S110 | 22.74 | 1.03 | 1.54 | 56.00 | 3.56 | L15 |
| S111 | −2.10 | 0.74 | | | | |
| S112 | −7.09 | 0.58 | 1.54 | 56.00 | −3.87 | L16 |
| S113 | 3.10 | 0.48 | | | | |
| S114 | ∞ | 0.21 | 1.52 | 64.17 | | OF1 |
| S115 | ∞ | 0.48 | | | | |

In the first embodiment, the conic constant k and the aspheric coefficients A, B, C, D, E of each aspheric lens are shown in Table 2.

TABLE 2

| Surface | | | | | | |
|---|---|---|---|---|---|---|
| Number | k | A | B | C | D | E |
| S11 | 0.000 | −8.94E−03 | 7.45E−04 | −2.05E−05 | 0.00E+00 | 0.00E+00 |
| S12 | −0.771 | 1.83E−02 | 4.04E−03 | 3.59E−04 | 0.00E+00 | 0.00E+00 |
| S13 | 0.000 | −1.47E−02 | −1.02E−02 | −6.40E−04 | 0.00E+00 | 0.00E+00 |
| S14 | 8.933 | −6.61E−03 | −3.16E−02 | 1.96E−02 | 0.00E+00 | 0.00E+00 |
| S16 | 0.460 | 1.86E−02 | −3.35E−02 | 1.44E−02 | −3.02E−03 | 0.00E+00 |
| S17 | −11.116 | −1.03E−01 | 5.88E−02 | −3.91E−02 | 1.16E−02 | 0.00E+00 |
| S18 | −100.000 | −1.15E−01 | 5.90E−03 | 2.44E−03 | 4.46E−03 | 0.00E+00 |
| S19 | −9.875 | −2.65E−02 | 1.69E−02 | −2.59E−03 | 1.00E−03 | 0.00E+00 |
| S110 | 40.800 | 2.52E−02 | −3.62E−03 | 6.06E−05 | 0.00E+00 | 0.00E+00 |
| S111 | −5.557 | −8.53E−03 | 9.88E−03 | −8.16E−04 | −5.96E−05 | 0.00E+00 |
| S112 | 0.000 | −3.87E−03 | −1.73E−02 | 7.46E−03 | −1.59E−03 | 1.27E−04 |
| S113 | 0.000 | −5.51E−02 | 8.49E−03 | −1.18E−03 | 8.65E−05 | −3.16E−06 |

Table 3 shows the parameters and condition values for conditions (1)-(10) in accordance with the first embodiment of the invention. It can be seen from Table 3 that the wide-angle lens assembly 1 of the first embodiment satisfies the conditions (1)-(10).

TABLE 3

| | | | | | |
|---|---|---|---|---|---|
| T1 | 0.59 | T2 | 1.18 | T3 | 1.03 |
| | mm | | mm | | mm |
| T4 | 0.47 | T5 | 1.03 | T6 | 0.58 |
| | mm | | mm | | mm |
| d34 | 0.01 | | | | |
| | mm | | | | |
| (R41 − R51) × | 24.68 | (f1 + f5)/d34 | 2.18 | (f1 − f6) × Vd4 | 6.73 |
| T3 | mm² | | | | mm |
| (R22)²/f3 | 32.82 | (T1 + T4 + | 4.26 | (f6)²/(R11 + | 18.44 |
| | mm | T5) × f3 | mm² | R22) | mm |
| R52/R61/d34 | 26.85 | R61/((f6/f4) + | 9.36 | Nd3/(R31 × | 54.51 |
| | mm⁻¹ | R52) | | d34) | mm⁻² |

| | |
|---|---|
| (T1 + T2 + T3 + T4 + T5 + T6)²/ | 153.08 mm |
| (R32 + R42) | |

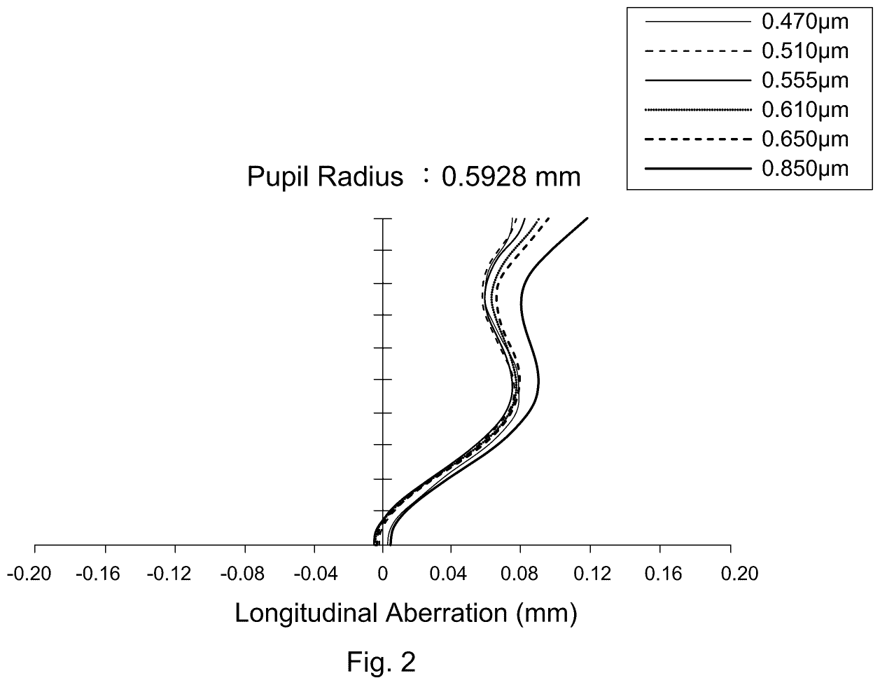

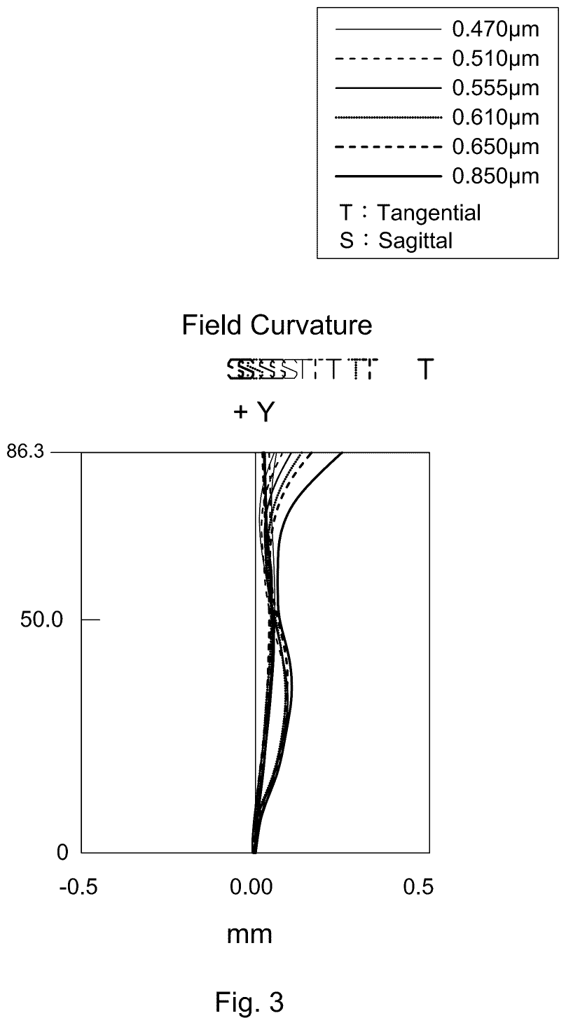

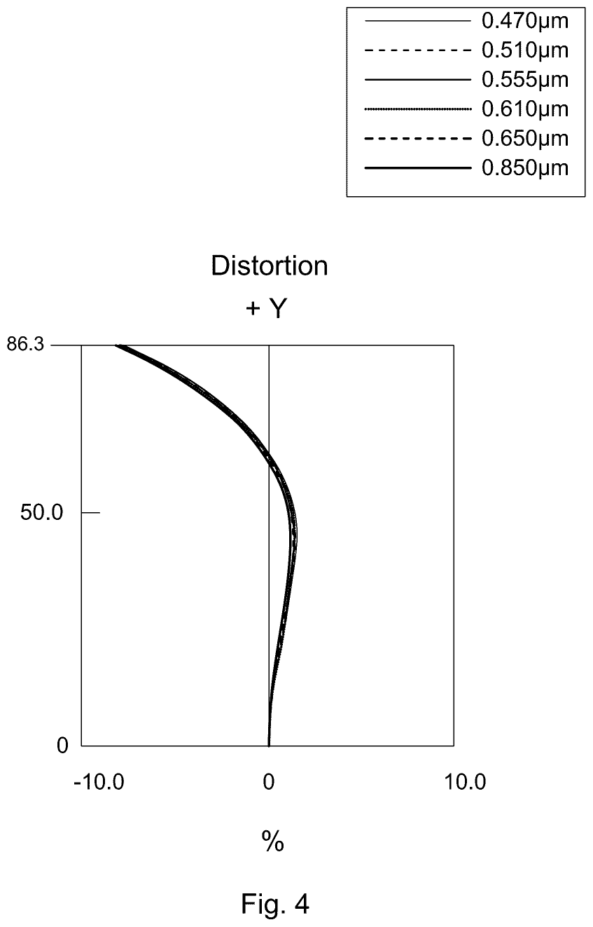

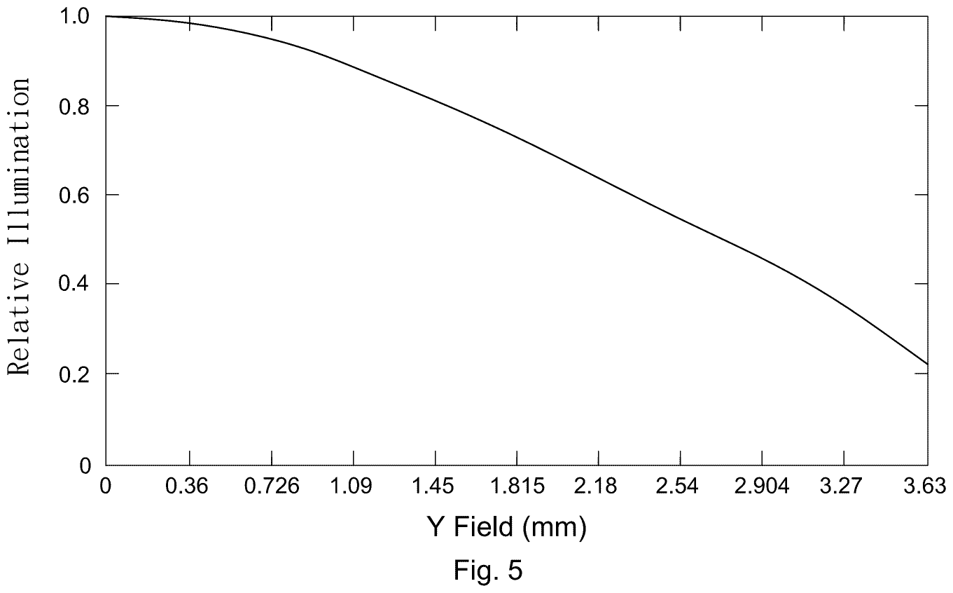

In addition, the wide-angle lens assembly 1 of the first embodiment can meet the requirements of optical performance as seen in FIGS. 2-5. It can be seen from FIG. 2 that the longitudinal aberration in the wide-angle lens assembly 1 of the first embodiment ranges from −0.01 mm to 0.12 mm. It can be seen from FIG. 3 that the field curvature of tangential direction and sagittal direction in the wide-angle lens assembly 1 of the first embodiment ranges from −0.02 mm to 0.25 mm. It can be seen from FIG. 4 that the distortion in the wide-angle lens assembly 1 of the first embodiment ranges from −8% to 2%. It can be seen from FIG. 5 that the relative illumination in the wide-angle lens assembly 1 of the first embodiment ranges from 0.21 to 1.0. It is obvious that the longitudinal aberration, the field curvature, and the distortion of the wide-angle lens assembly 1 of the first embodiment can be corrected effectively. Therefore, the wide-angle lens assembly 1 of the first embodiment is capable of good optical performance.

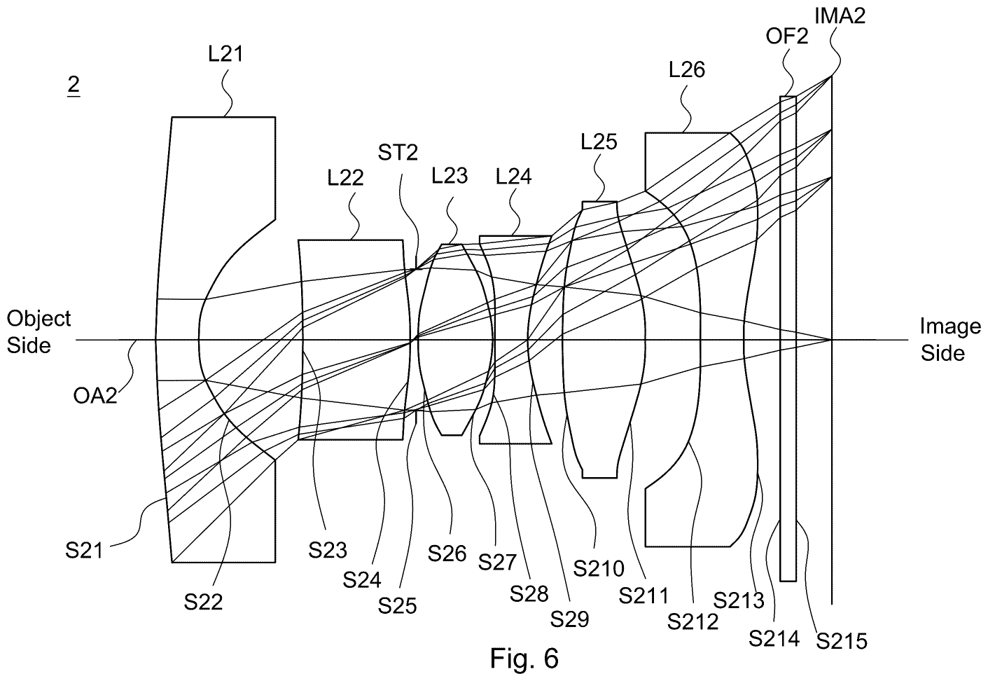

A detailed description of a wide-angle lens assembly in accordance with a second embodiment of the invention is as follows. Referring to FIG. 6, the wide-angle lens assembly 2 includes a first lens L21, a second lens L22, a stop ST2, a third lens L23, a fourth lens L24, a fifth lens L25, a sixth lens L26, and an optical filter OF2, all of which are arranged in order from an object side to an image side along an optical axis OA2. In operation, the light from the object side is imaged on an image plane IMA2.

According to the foregoing, wherein: both of the object side surface S214 and image side surface S215 of the optical filter OF2 are plane surfaces; and with the above design of the lenses, stop ST2, and at least one of the conditions (1)-(10) satisfied, the wide-angle lens assembly 2 can have an effective increased field of view, an effective shortened total lens length, an effective increased resolution, and an effective corrected aberration.

Table 4 shows the optical specification of the wide-angle lens assembly 2 in FIG. 6.

TABLE 4
Effective Focal Length = 2.52 mm F-number = 2.20
Total Lens Length = 9.35 mm Field of View = 165.94 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S21 | 9.26 | 0.59 | 1.54 | 56.00 | −3.98 | L21 |
| S22 | 1.54 | 1.43 | | | | |
| S23 | 21.81 | 1.50 | 1.64 | 23.97 | 8.13 | L22 |
| S24 | −7.27 | 0.07 | | | | |
| S25 | ∞ | 0.04 | | | | ST2 |
| S26 | 2.98 | 1.03 | 1.54 | 56.00 | 5.02 | L23 |
| S27 | −1.74 | 0.02 | | | | |
| S28 | 46.80 | 0.47 | 1.66 | 20.38 | −2.75 | L24 |
| S29 | 1.84 | 0.47 | | | | |
| S210 | 12.26 | 1.15 | 1.54 | 56.00 | 3.98 | L25 |
| S211 | −2.37 | 0.77 | | | | |
| S212 | −9.87 | 0.59 | 1.54 | 56.00 | −4.26 | L26 |
| S213 | 3.28 | 0.50 | | | | |
| S214 | ∞ | 0.21 | 1.52 | 64.17 | | OF2 |
| S215 | ∞ | 0.50 | | | | |

In the second embodiment, the conic constant k and the aspheric coefficients A, B, C, D, E of each aspheric lens are shown in Table 5.

TABLE 5

| Surface | | | | | | |
|---|---|---|---|---|---|---|
| Number | k | A | B | C | D | E |
| S21 | 0.000 | −7.09E−03 | 5.05E−04 | −1.24E−05 | 0.00E+00 | 0.00E+00 |
| S22 | −1.054 | 2.41E−02 | 2.94E−03 | −2.17E−04 | 0.00E+00 | 0.00E+00 |
| S23 | 0.000 | −1.29E−02 | −7.31E−03 | −1.80E−04 | 0.00E+00 | 0.00E+00 |
| S24 | −14.373 | 5.47E−03 | −3.41E−02 | 1.82E−02 | 0.00E+00 | 0.00E+00 |
| S26 | 0.917 | 3.69E−02 | −4.24E−02 | 1.74E−02 | −2.50E−03 | 0.00E+00 |
| S27 | −11.731 | −9.83E−02 | 6.06E−02 | −3.99E−02 | 1.20E−02 | 0.00E+00 |
| S28 | −100.000 | −1.05E−01 | 5.94E−03 | 1.96E−03 | 2.93E−03 | 0.00E+00 |
| S29 | −9.599 | −2.34E−02 | 1.45E−02 | −1.82E−03 | 5.23E−04 | 0.00E+00 |
| S210 | −100.000 | 2.73E−02 | −5.02E−03 | 5.58E−04 | 0.00E+00 | 0.00E+00 |
| S211 | −6.245 | −7.66E−03 | 7.40E−03 | −1.40E−03 | 1.49E−04 | 0.00E+00 |
| S212 | 0.000 | −1.42E−02 | −1.11E−02 | 4.04E−03 | −8.50E−04 | 6.44E−05 |
| S213 | 0.000 | −4.87E−02 | 7.15E−03 | −1.00E−03 | 7.84E−05 | −2.96E−06 |

Table 6 shows the parameters and condition values for conditions (1)-(10) in accordance with the second embodiment of the invention. It can be seen from Table 6 that the wide-angle lens assembly 2 of the second embodiment satisfies the conditions (1)-(10).

TABLE 6

| | | | | | |
|---|---|---|---|---|---|
| T1 | 0.59 | T2 | 1.50 | T3 | 1.03 |
| | mm | | mm | | mm |
| T4 | 0.47 | T5 | 1.15 | T6 | 0.59 |
| | mm | | mm | | mm |
| d34 | 0.02 | | | | |
| | mm | | | | |
| (R41 − R51) × | 35.45 | (f1 + f5)/d34 | 0.12 | (f1 − f6) × Vd4 | 5.71 |
| T3 | mm² | | | | mm |
| (R22)²/f3 | 10.51 | (T1 + T4 + | 11.13 | (f6)²/(R11 + | 9.09 |
| | mm | T5) × f3 | mm² | R22) | mm |
| R52/R61/d34 | 9.61 | R61/((f6/f4) + | 12.02 | Nd3/(R31 × | 20.76 |
| | mm⁻¹ | R52) | | d34) | mm⁻² |

| | |
|---|---|
| (T1 + T2 + T3 + T4 + T5 + T6)²/ | 273.91 mm |
| (R32 + R42) | |

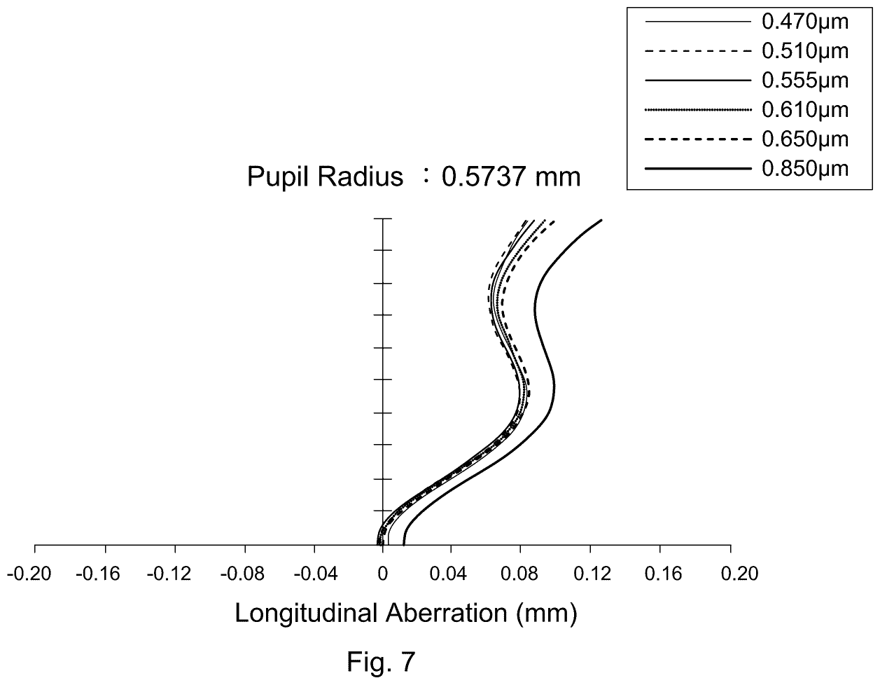

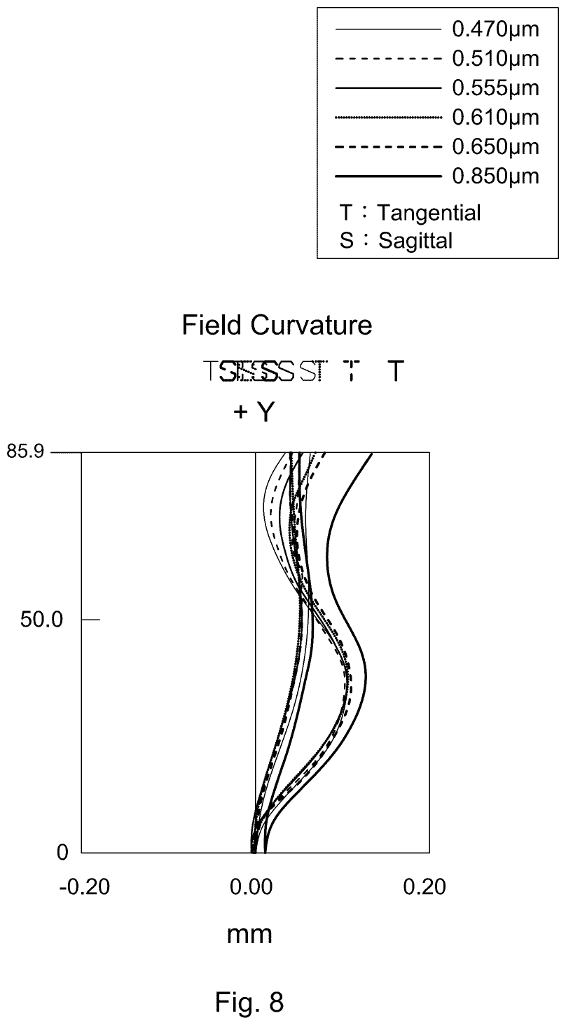

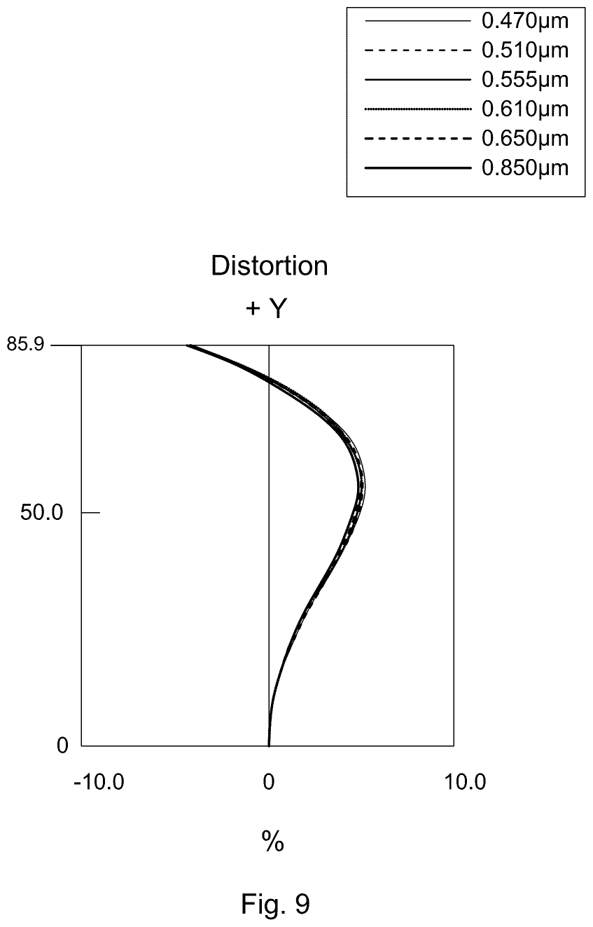

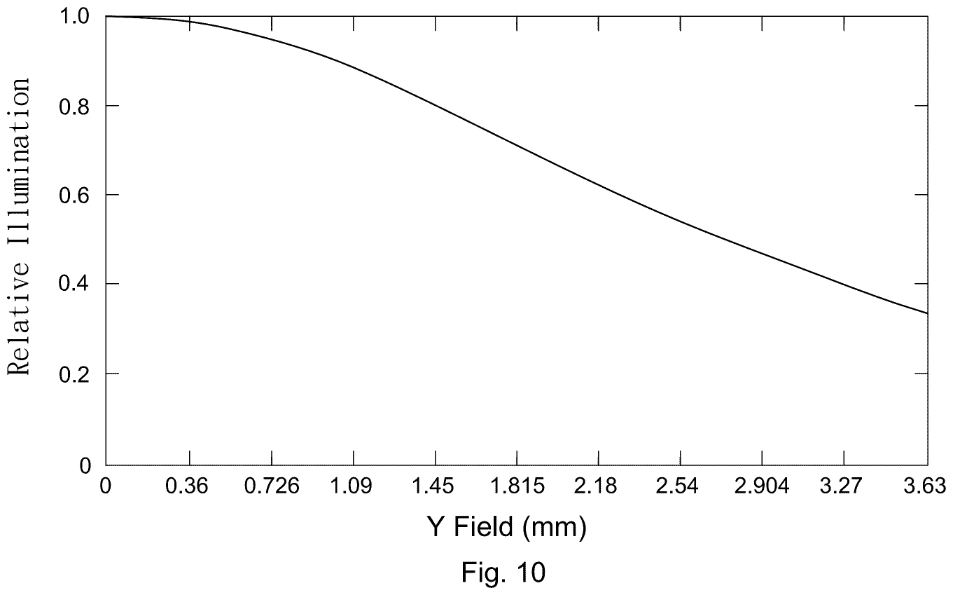

In addition, the wide-angle lens assembly 2 of the second embodiment can meet the requirements of optical performance as seen in FIGS. 7-10. It can be seen from FIG. 7 that the longitudinal aberration in the wide-angle lens assembly 2 of the second embodiment ranges from −0.01 mm to 0.14 mm. It can be seen from FIG. 8 that the field curvature of tangential direction and sagittal direction in the wide-angle lens assembly 2 of the second embodiment ranges from −0.01 mm to 0.14 mm. It can be seen from FIG. 9 that the distortion in the wide-angle lens assembly 2 of the second embodiment ranges from −5% to 5%. It can be seen from FIG. 10 that the relative illumination in the wide-angle lens assembly 2 of the second embodiment ranges from 0.32 to 1.0. It is obvious that the longitudinal aberration, the field curvature, and the distortion of the wide-angle lens assembly 2 of the second embodiment can be corrected effectively. Therefore, the wide-angle lens assembly 2 of the second embodiment is capable of good optical performance.

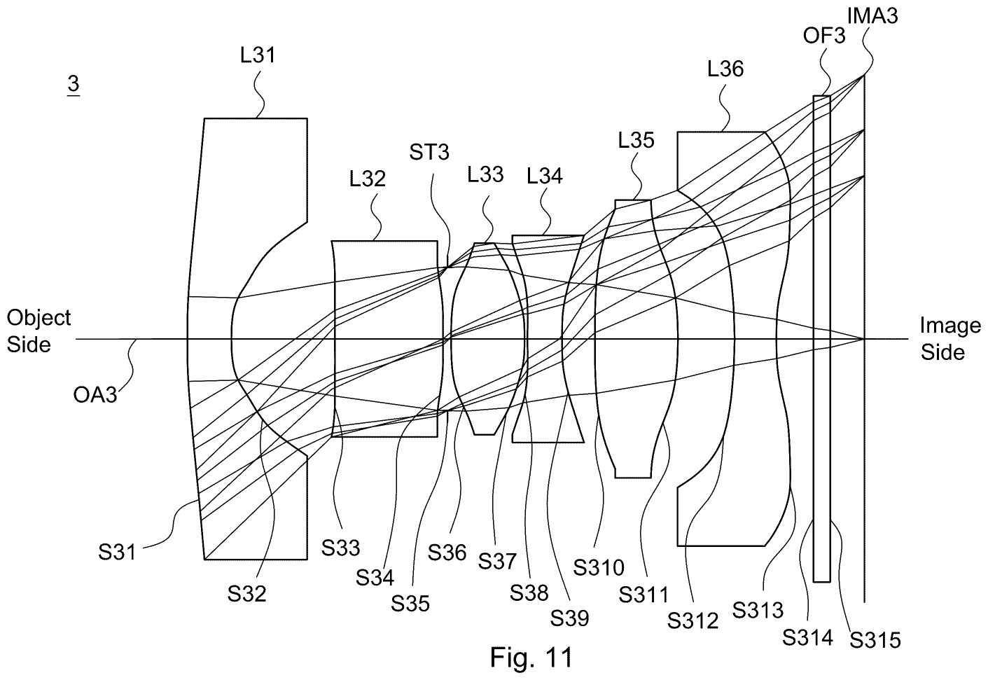

A detailed description of a wide-angle lens assembly in accordance with a third embodiment of the invention is as follows. Referring to FIG. 11, the wide-angle lens assembly 3 includes a first lens L31, a second lens L32, a stop ST3, a third lens L33, a fourth lens L34, a fifth lens L35, a sixth lens L36, and an optical filter OF3, all of which are arranged in order from an object side to an image side along an optical axis OA3. In operation, the light from the object side is imaged on an image plane IMA3.

According to the foregoing, wherein: both of the object side surface S314 and image side surface S315 of the optical filter OF3 are plane surfaces; and with the above design of the lenses, stop ST3, and at least one of the conditions (1)-(10) satisfied, the wide-angle lens assembly 3 can have an effective increased field of view, an effective shortened total lens length, an effective increased resolution, and an effective corrected aberration.

Table 7 shows the optical specification of the wide-angle lens assembly 3 in FIG. 11.

TABLE 7
Effective Focal Length = 2.53 mm F-number = 2.20
Total Lens Length = 9.36 mm Field of View = 166.00 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S31 | 9.07 | 0.59 | 1.54 | 56.00 | −3.47 | L31 |
| S32 | 1.53 | 1.43 | | | | |
| S33 | 21.90 | 1.50 | 1.64 | 23.97 | 8.70 | L32 |
| S34 | −7.27 | 0.07 | | | | |
| S35 | ∞ | 0.04 | | | | ST3 |
| S36 | 2.97 | 1.02 | 1.54 | 56.00 | 2.17 | L33 |
| S37 | −1.73 | 0.03 | | | | |
| S38 | 52.58 | 0.48 | 1.66 | 20.38 | −2.87 | L34 |
| S39 | 1.84 | 0.47 | | | | |
| S310 | 11.59 | 1.15 | 1.54 | 56.00 | 3.73 | L35 |
| S311 | −2.39 | 0.77 | | | | |
| S312 | −9.71 | 0.59 | 1.54 | 56.00 | −4.43 | L36 |
| S313 | 3.29 | 0.50 | | | | |
| S314 | ∞ | 0.21 | 1.52 | 64.17 | | OF3 |
| S315 | ∞ | 0.50 | | | | |

In the third embodiment, the conic constant k and the aspheric coefficients A, B, C, D, E of each aspheric lens are shown in Table 8.

TABLE 8

| Surface | | | | | | |
|---|---|---|---|---|---|---|
| Number | k | A | B | C | D | E |
| S31 | 0.000 | −7.29E−03 | 5.19E−04 | −1.28E−05 | 0.00E+00 | 0.00E+00 |
| S32 | −1.060 | 2.44E−02 | 3.01E−03 | −2.32E−04 | 0.00E+00 | 0.00E+00 |
| S33 | 0.000 | −1.28E−02 | −7.26E−03 | −2.37E−04 | 0.00E+00 | 0.00E+00 |
| S34 | −19.980 | 2.48E−03 | −3.25E−02 | 1.76E−02 | 0.00E+00 | 0.00E+00 |
| S36 | 0.910 | 3.55E−02 | −4.09E−02 | 1.64E−02 | −2.27E−03 | 0.00E+00 |
| S37 | −11.819 | −9.75E−02 | 5.98E−02 | −3.94E−02 | 1.18E−02 | 0.00E+00 |
| S38 | −100.000 | −1.02E−01 | 3.81E−03 | 3.29E−03 | 2.55E−03 | 0.00E+00 |
| S39 | −9.713 | −2.20E−02 | 1.34E−02 | −1.29E−03 | 4.03E−04 | 0.00E+00 |
| S310 | −100.000 | 2.76E−02 | −5.22E−03 | 6.00E−04 | 0.00E+00 | 0.00E+00 |
| S311 | −6.515 | −9.33E−03 | 8.31E−03 | −1.72E−03 | 1.89E−04 | 0.00E+00 |
| S312 | 0.000 | −1.47E−02 | −1.09E−02 | 4.03E−03 | −8.58E−04 | 6.47E−05 |
| S313 | 0.000 | −4.87E−02 | 7.17E−03 | −1.00E−03 | 7.80E−05 | −2.90E−06 |

Table 9 shows the parameters and condition values for conditions (1)-(10) in accordance with the third embodiment of the invention. It can be seen from Table 9 that the wide-angle lens assembly 3 of the third embodiment satisfies the conditions (1)-(10).

TABLE 9

| | | | | | |
|---|---|---|---|---|---|
| T1 | 0.59 | T2 | 1.50 | T3 | 1.02 |
| | mm | | mm | | mm |
| T4 | 0.48 | T5 | 1.15 | T6 | 0.59 |
| | mm | | mm | | mm |
| d34 | 0.03 | | | | |
| | mm | | | | |
| (R41 − R51) × | 41.89 | (f1 + f5)/d34 | 10.64 | (f1 − f6) × Vd4 | 19.61 |
| T3 | mm² | | | | mm |
| (R22)²/f3 | 24.35 | (T1 + T4 + | 4.83 | (f6)²/(R11 + | 10.89 |
| | mm | T5) × f3 | mm² | R22) | mm |
| R52/R61/d34 | 9.83 | R61/((f6/f4) + | 11.50 | Nd3/(R31 × | 20.79 |
| | mm⁻¹ | R52) | | d34) | mm⁻² |

| | |
|---|---|
| (T1 + T2 + T3 + T4 + T5 + T6)²/ | 266.60 mm |
| (R32 + R42) | |

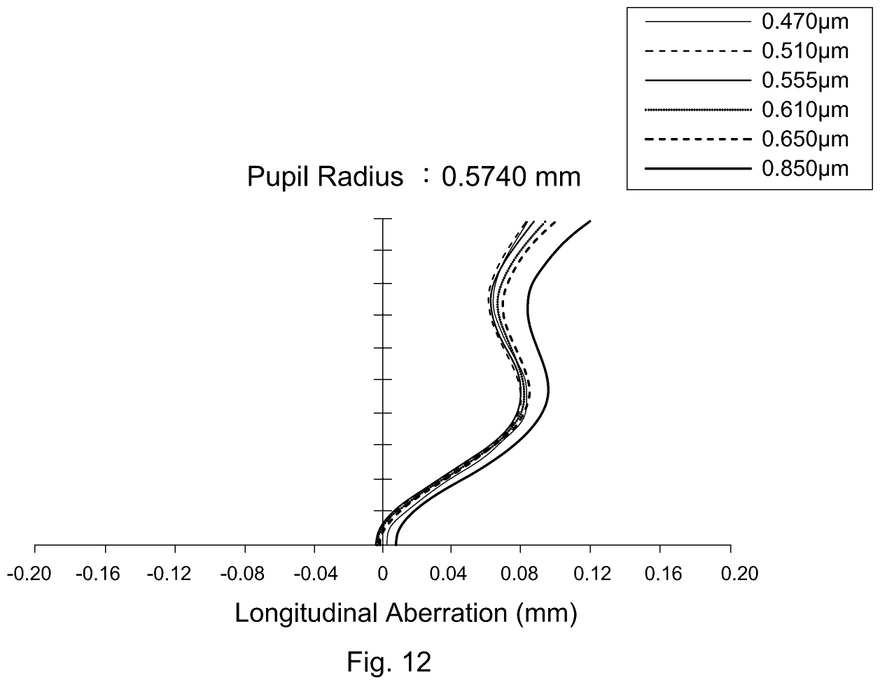

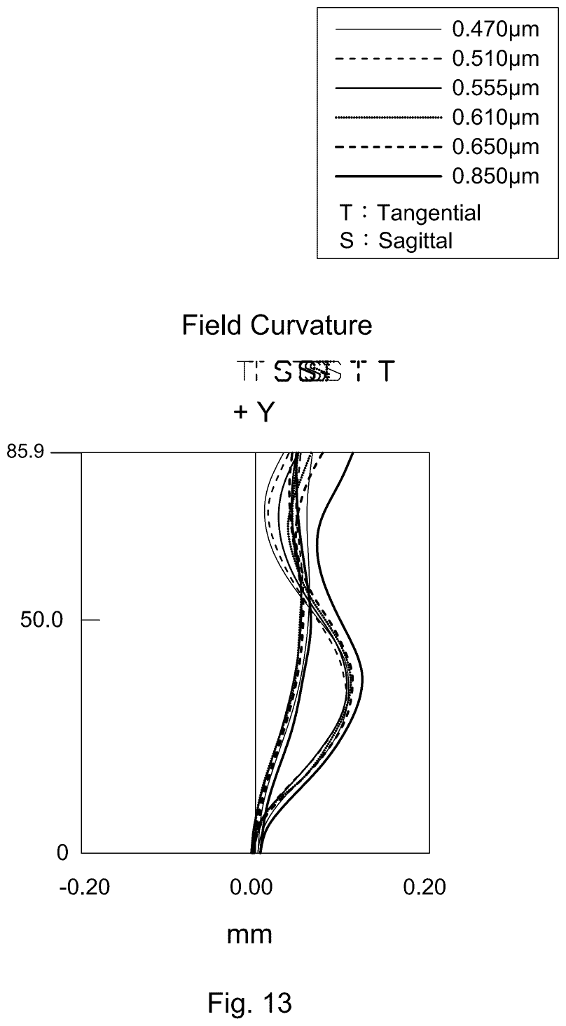

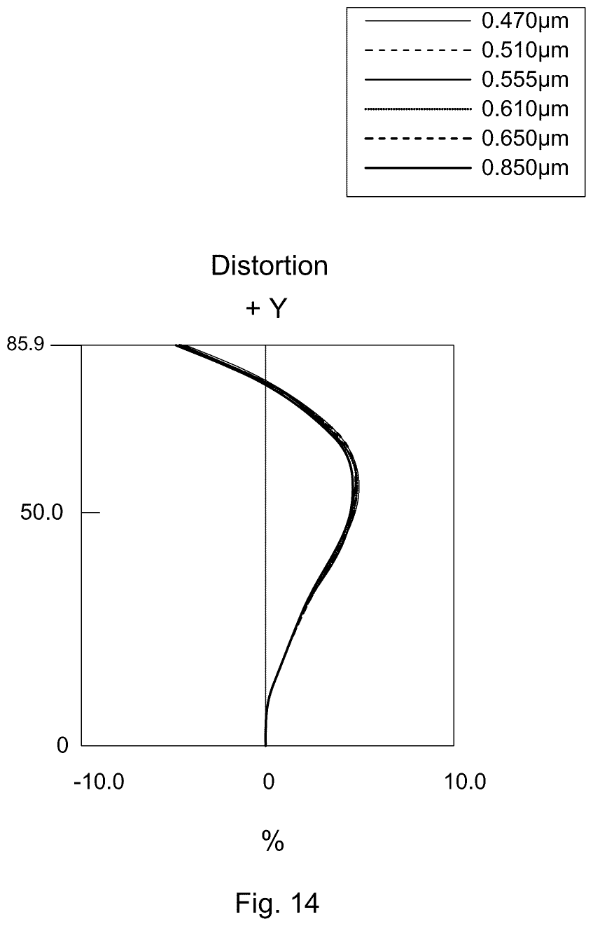

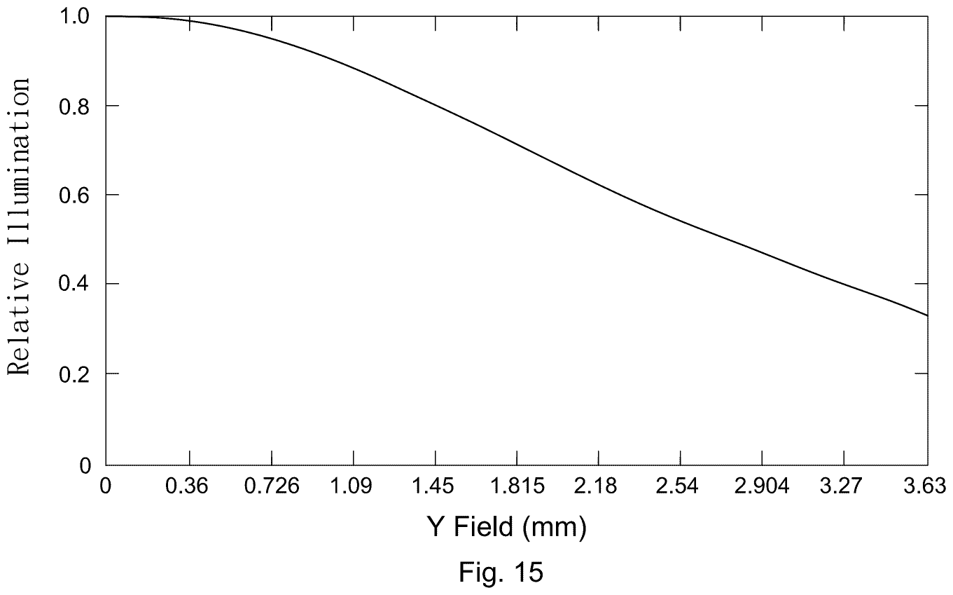

In addition, the wide-angle lens assembly 3 of the third embodiment can meet the requirements of optical performance as seen in FIGS. 12-15. It can be seen from FIG. 12 that the longitudinal aberration in the wide-angle lens assembly 3 of the third embodiment ranges from −0.01 mm to 0.12 mm. It can be seen from FIG. 13 that the field curvature of tangential direction and sagittal direction in the wide-angle lens assembly 3 of the third embodiment ranges from −0.01 mm to 0.14 mm. It can be seen from FIG. 14 that the distortion in the wide-angle lens assembly 3 of the third embodiment ranges from −5% to 5%. It can be seen from FIG. 15 that the relative illumination in the wide-angle lens assembly 3 of the third embodiment ranges from 0.32 to 1.0. It is obvious that the longitudinal aberration, the field curvature, and the distortion of the wide-angle lens assembly 3 of the third embodiment can be corrected effectively. Therefore, the wide-angle lens assembly 3 of the third embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures. What is claimed is:
1. A wide-angle lens assembly comprising:
a first lens which is with refractive power;
a second lens which is with refractive power and comprises a convex surface facing an object side;
a third lens which is with positive refractive power;
a fourth lens which is with refractive power and comprises a convex surface facing the object side;
a fifth lens which is with positive refractive power and comprises a convex surface facing the object side; and
a sixth lens which is with refractive power and comprises a concave surface facing an image side;
wherein the first lens, the second lens, the third lens, the fourth lens, the fifth lens, and the sixth lens are arranged in order from the object side to the image side along an optical axis.

2. The wide-angle lens assembly as claimed in claim 1, wherein the wide-angle lens assembly satisfies at least one of following conditions:
$$24 {mm}^{2} \leq ( R 41 - R 51 ) \times T 3 \leq 42 {mm}^{2} ;$$
$$0.1 \leq ( f 1 + f 5 ) / d 34 \leq 10.7 ;$$
$$5.01 mm \leq ( f 1 - f 6 ) \times Vd 4 \leq 20.31 mm ;$$
$$10 mm \leq {( R 22 )}^{2} / f 3 \leq 33 mm ;$$
$$3.9 {mm}^{2} \leq ( T 1 + T 4 + T 5 ) \times f 3 \leq 11.5 {mm}^{2} ;$$
$$9 mm \leq {( f 6 )}^{2} / ( R 11 + R 22 ) \leq 19 mm ;$$
$$9.5 {mm}^{- 1} \leq R 52 / R 61 / d 34 \leq 27.2 {mm}^{- 1} ;$$
$$9 \leq ( R 61 ) / ( ( f 6 / f 4 ) + R 52 ) \leq 12.2 ;$$
$$20 {mm}^{- 2} \leq Nd 3 / ( R 31 \times d 34 ) \leq 55 {mm}^{- 2} ;$$
$$152 mm \leq {( T 1 + T 2 + T 3 + T 4 + T 5 + T 6 )}^{2} / ( R 32 + R 42 ) \leq 274 mm ;$$
wherein f1 is an effective focal length of the first lens, f3 is an effective focal length of the third lens, f4 is an effective focal length of the fourth lens, f5 is an effective focal length of the fifth lens, f6 is an effective focal length of the sixth lens, T1 is an interval from an object side surface of the first lens to an image side surface of the first lens along the optical axis, T2 is an interval from an object side surface of the second lens to an image side surface of the second lens along the optical axis, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, R42 is a radius of curvature of the image side surface of the fourth lens, R51 is a radius of curvature of the object side surface of the fifth lens, R52 is a radius of curvature of the image side surface of the fifth lens, R61 is a radius of curvature of the object side surface of the sixth lens, d34 is an air interval from the image side surface of the third lens to the object side surface of the fourth lens along the optical axis, Vd4 is an Abbe number of the fourth lens, and Nd3 is a refractive index of the third lens.

3. The wide-angle lens assembly as claimed in claim 1, wherein:
the first lens is with negative refractive power;
the fourth lens is with negative refractive power; and
the sixth lens is with negative refractive power.

4. The wide-angle lens assembly as claimed in claim 3, wherein:
the first lens is a meniscus lens and comprises a convex surface facing the object side and a concave surface facing the image side;
the third lens is a biconvex lens and comprises a convex surface facing the object side and another convex surface facing the image side;
the fourth lens is a meniscus lens and further comprises a concave surface facing the image side;
the fifth lens is a biconvex lens and further comprises another convex surface facing the image side; and
the sixth lens is a biconcave lens and further comprises another concave surface facing the object side.

5. The wide-angle lens assembly as claimed in claim 4, further comprising a stop disposed between the second lens and the third lens.

6. The wide-angle lens assembly as claimed in claim 1, wherein the second lens is a biconvex lens with positive refractive power and further comprises another convex surface facing the image side.

7. The wide-angle lens assembly as claimed in claim 6, wherein the wide-angle lens assembly satisfies at least one of following conditions:
$$24 {mm}^{2} \leq ( R 41 - R 51 ) \times T 3 \leq 42 {mm}^{2} ;$$
$$0.1 \leq ( f 1 + f 5 ) / d 34 \leq 10.7 ;$$
$$5.01 mm \leq ( f 1 - f 6 ) \times Vd 4 \leq 20.31 mm ;$$
$$10 mm \leq {( R 22 )}^{2} / f 3 \leq 33 mm ;$$
$$3.9 {mm}^{2} \leq ( T 1 + T 4 + T 5 ) \times f 3 \leq 11.5 {mm}^{2} ;$$
$$9 mm \leq {( f 6 )}^{2} / ( R 11 + R 22 ) \leq 19 mm ;$$
$$9.5 {mm}^{- 1} \leq R 52 / R 61 / d 34 \leq 27.2 {mm}^{- 1} ;$$
$$9 \leq ( R 61 ) / ( ( f 6 / f 4 ) + R 52 ) \leq 12.2 ;$$
$$20 {mm}^{- 2} \leq Nd 3 / ( R 31 \times d 34 ) \leq 55 {mm}^{- 2} ;$$
$$152 mm \leq {( T 1 + T 2 + T 3 + T 4 + T 5 + T 6 )}^{2} / ( R 32 + R 42 ) \leq 274 mm ;$$
wherein f1 is an effective focal length of the first lens, f3 is an effective focal length of the third lens, f4 is an effective focal length of the fourth lens, f5 is an effective focal length of the fifth lens, f6 is an effective focal length of the sixth lens, T1 is an interval from an object side surface of the first lens to an image side surface of the first lens along the optical axis, T2 is an interval from an object side surface of the second lens to an image side surface of the second lens along the optical axis, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, R42 is a radius of curvature of the image side surface of the fourth lens, R51 is a radius of curvature of the object side surface of the fifth lens, R52 is a radius of curvature of the image side surface of the fifth lens, R61 is a radius of curvature of the object side surface of the sixth lens, d34 is an air interval from the image side surface of the third lens to the object side surface of the fourth lens along the optical axis, Vd4 is an Abbe number of the fourth lens, and Nd3 is a refractive index of the third lens.

8. The wide-angle lens assembly as claimed in claim 6, wherein:
the first lens is with negative refractive power;
the fourth lens is with negative refractive power; and
the sixth lens is with negative refractive power.

9. The wide-angle lens assembly as claimed in claim 8, wherein:
the first lens is a meniscus lens and comprises a convex surface facing the object side and a concave surface facing the image side;
the third lens is a biconvex lens and comprises a convex surface facing the object side and another convex surface facing the image side;
the fourth lens is a meniscus lens and further comprises a concave surface facing the image side;
the fifth lens is a biconvex lens and further comprises another convex surface facing the image side; and
the sixth lens is a biconcave lens and further comprises another concave surface facing the object side.

10. The wide-angle lens assembly as claimed in claim 9, further comprising a stop disposed between the second lens and the third lens.

11. A wide-angle lens assembly comprising:
a first lens which is with refractive power;
a second lens which is a biconvex lens with positive refractive power and comprises a convex surface facing an object side and another convex surface facing an image side;
a third lens which is with positive refractive power;
a fourth lens which is with refractive power and comprises a convex surface facing the object side;
a fifth lens which is with refractive power; and
a sixth lens which is with refractive power and comprises a concave surface facing the image side;
wherein the first lens, the second lens, the third lens, the fourth lens, the fifth lens, and the sixth lens are arranged in order from the object side to the image side along an optical axis.

12. The wide-angle lens assembly as claimed in claim 11, wherein the wide-angle lens assembly satisfies at least one of following conditions:
$$24 {mm}^{2} \leq ( R 41 - R 51 ) \times T 3 \leq 42 {mm}^{2} ;$$
$$0.1 \leq ( f 1 + f 5 ) / d 34 \leq 10.7 ;$$
$$5.01 mm \leq ( f 1 - f 6 ) \times Vd 4 \leq 20.31 mm ;$$
$$10 mm \leq {( R 22 )}^{2} / f 3 \leq 33 mm ;$$
$$3.9 {mm}^{2} \leq ( T 1 + T 4 + T 5 ) \times f 3 \leq 11.5 {mm}^{2} ;$$
$$9 mm \leq {( f 6 )}^{2} / ( R 11 + R 22 ) \leq 19 mm ;$$
$$9.5 {mm}^{- 1} \leq R 52 / R 61 / d 34 \leq 27.2 {mm}^{- 1} ;$$
$$9 \leq ( R 61 ) / ( ( f 6 / f 4 ) + R 52 ) \leq 12.2 ;$$
$$20 {mm}^{- 2} \leq Nd 3 / ( R 31 \times d 34 ) \leq 55 {mm}^{- 2} ;$$
$$152 mm \leq {( T 1 + T 2 + T 3 + T 4 + T 5 + T 6 )}^{2} / ( R 32 + R 42 ) \leq 274 mm ;$$
wherein f1 is an effective focal length of the first lens, f3 is an effective focal length of the third lens, f4 is an effective focal length of the fourth lens, f5 is an effective focal length of the fifth lens, f6 is an effective focal length of the sixth lens, T1 is an interval from an object side surface of the first lens to an image side surface of the first lens along the optical axis, T2 is an interval from an object side surface of the second lens to an image side surface of the second lens along the optical axis, T3 is an interval from an object side surface of the third lens to an image side surface of the third lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, R42 is a radius of curvature of the image side surface of the fourth lens, R51 is a radius of curvature of the object side surface of the fifth lens, R52 is a radius of curvature of the image side surface of the fifth lens, R61 is a radius of curvature of the object side surface of the sixth lens, d34 is an air interval from the image side surface of the third lens to the object side surface of the fourth lens along the optical axis, Vd4 is an Abbe number of the fourth lens, and Nd3 is a refractive index of the third lens.

13. The wide-angle lens assembly as claimed in claim 12, wherein:
the first lens is with negative refractive power;
the fourth lens is with negative refractive power; and
the sixth lens is with negative refractive power.

14. The wide-angle lens assembly as claimed in claim 13, wherein:
the first lens is a meniscus lens and comprises a convex surface facing the object side and a concave surface facing the image side;
the third lens is a biconvex lens and comprises a convex surface facing the object side and another convex surface facing the image side;
the fourth lens is a meniscus lens and further comprises a concave surface facing the image side;
the fifth lens is a biconvex lens and comprises a convex surface facing the object side and another convex surface facing the image side; and
the sixth lens is a biconcave lens and further comprises another concave surface facing the object side.

15. The wide-angle lens assembly as claimed in claim 14, further comprising a stop disposed between the second lens and the third lens.

16. The wide-angle lens assembly as claimed in claim 11, wherein:
the first lens is with negative refractive power;
the fourth lens is with negative refractive power; and
the sixth lens is with negative refractive power.

17. The wide-angle lens assembly as claimed in claim 16, wherein:
the first lens is a meniscus lens and comprises a convex surface facing the object side and a concave surface facing the image side;
the third lens is a biconvex lens and comprises a convex surface facing the object side and another convex surface facing the image side;
the fourth lens is a meniscus lens and further comprises a concave surface facing the image side;
the fifth lens is a biconvex lens and comprises a convex surface facing the object side and another convex surface facing the image side; and
the sixth lens is a biconcave lens and further comprises another concave surface facing the object side.

18. The wide-angle lens assembly as claimed in claim 17, further comprising a stop disposed between the second lens and the third lens.
